(19) United States
(12) Patent Application Publication
(10) Pub. No.: US 2011/0206894 A1
(43) Pub. Date: Aug. 25, 2011

(54) Crash Energy Absorbing Furniture Top

(76) Inventor: Irwin Y.W. Tsai, Millbrae, CA (US)

(21) Appl. No.: 12/712,154

(22) Filed: Feb. 24, 2010

(51) Int. Cl. B32B 3/10; B32B 3/12

(52) U.S. Cl. 428/116; 428/198

(57) ABSTRACT

Crash energy absorbing furniture top with a top skin, a bottom skin and an energy absorbing material disposed between the top and bottom skin is disclosed. The crash energy absorbing material may be disposed between the top skin and the bottom skin, the crash energy absorbing material being bonded to the top skin in a substantially regular pattern of bonded areas. The energy absorbing furniture top absorbs energy by deforming when an individual collides with the energy absorbing furniture top. The deforming of the crash energy absorbing furniture top reduces the risk of injury to the individual in a collision.

### FIELD

This application relates generally to crash energy absorbing equipment for use in transportation, and particularly to crash energy absorbing furniture within a passenger vehicle.

### BACKGROUND

Millions of people ride in large vehicles that include working surfaces for use during transit, such as tables, each year. Large transportation vehicles such as trains, buses, RV's, boats, etc., can provide a comfortable travel experience with sufficient room for tables to be used for work and entertainment during travel. Generally, such vehicles do not include seatbelts. Because safety restraints are not common and are largely undesirable due to the various advantages of travelling in large vehicles, when one of these vehicles is involved in an accident, passengers may be thrown around the interior of the vehicle and injured by fixtures in the interior of the vehicle.

Tables in large transportation vehicles are generally solidly built to provide a stable work surface and to provide damage resistance due to jolts and vibrations common in vehicles. Because of the solid nature of the tables and the usefulness and proximity of the tables to seating, tables can present a danger to passengers in the case of an accident or emergency stop. In mass transportation vehicles such as trains that commonly have tables, a passenger seated at a table is likely to be thrown into the table, which can result in serious injury to the passenger by the table.

### SUMMARY

Embodiments of a crash energy absorbing furniture top are discussed and claimed, such embodiments including a top skin, a bottom skin, and an energy absorbing material disposed between the top skin and the bottom skin. The energy absorbing material is bonded to the top skin in a substantially regular pattern of bonded areas, thereby enabling the crash energy absorbing furniture top to absorb energy by deforming when an individual collides with it, the deforming reducing the risk of injury to the individual.

The bonded areas may be lines parallel to the non-bonded areas and parallel to an edge of the body. The bonded areas may also include a portion extending around the perimeter of the body. In some embodiments, the bonding pattern can have six bonded parallel lines separated by five non-bonded lines. The bottom skin may be bonded to the energy absorbing material in the same pattern as the top skin.

The body may be a table top configured to deform when an individual collides with the body, the deformation reducing the risk of injury to the individual. The energy absorbing material may be a honeycomb shaped material formed of aluminum, paper, plastic, or other suitable material. Similarly, the skin may be formed from aluminum, steel, plastic, laminate, or other suitable material.

In one embodiment, the crash energy absorbing furniture top for use in a moving vehicle comprises a top skin, a bottom skin, and a crash energy absorbing material disposed between the top skin and the bottom skin, the crash energy absorbing material being bonded to the top skin in a substantially regular pattern of bonded areas, the crash energy absorbing furniture top being capable of absorbing energy by deforming when an individual collides with the crash energy absorbing furniture top, the deforming reducing the risk of injury to the individual. In some embodiments, a total bonded area is generally equal to a total non-bonded area. In other embodiments, the regular pattern is a pattern of alternating stripes of bonded areas and non-bonded areas. In some of these embodiments, the stripes are parallel to an edge of the crash energy absorbing furniture top.

In some embodiments, the furniture top is a table top. In some embodiments, the crash energy absorbing material is a honeycomb shaped material. In some embodiments, the crash energy absorbing material is formed of aluminum. In some embodiments, the top skin is made of aluminum. In some embodiments, the crash energy absorbing furniture top is generally rectangular. In some embodiments, the crash energy absorbing material is formed of paper. In other embodiments, the crash energy absorbing material is formed of plastic.

In some embodiments, the bonded area includes a portion extending around the exterior perimeter of the body. In some embodiments, the bonding pattern has six bonded parallel stripes separated by five non-bonded stripes. In some embodiments, the bottom skin is bonded to the crash energy absorbing material in the same pattern as the top skin. In some embodiments, wherein the regular pattern is a wavy stripe pattern of alternating bonded and non-bonded striped areas. In other embodiments, the regular pattern is circles of bonded areas separated by non-bonded area. In other embodiments, the regular pattern includes repeating geometric shapes of bonded areas.

### BRIEF DESCRIPTION OF THE DRAWINGS

The following description can be better understood in light of Figures, in which:

FIG. 1 is a side view illustration of an exemplary embodiment of a crash energy absorbing table;

FIG. 2 is a cut-away view illustration of the crash energy absorbing table illustrated in FIG. 1 along line 2-2;

FIG. 3 is a cut-away view illustration of the crash energy absorbing table illustrated in FIG. 1 along line 3-3;

FIG. 4 is a top view illustration of the crash energy absorbing table of FIG. 1;

FIG. 5 is a top view illustration of a bonding pattern in an exemplary crash energy absorbing table;

FIG. 6 is a top view illustration of a bonding pattern in an exemplary crash energy absorbing table; and

FIG. 7 is a perspective view of an exemplary embodiment of a crash energy absorbing table installed in a vehicle.

Together with the following description, the Figures demonstrate and explain the principles of inventive crash energy absorbing tables and methods for using and making the tables. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that embodiments of crash energy absorbing tables and associated methods of using the tables can be implemented and used without employing these specific details. Indeed, exemplary embodiments and associated methods can be placed into practice by modifying the illustrated units and associated methods and can be used in conjunction with any other devices and techniques conventionally used in the industry. For example, while the description below focuses on an embodiment used in a passenger train, the tables and associated methods could be equally applied with other situations, such as counter-tops, cabinets, and other fixtures in a variety of vehicles in addition to trains, such as boats, ships, RVs, camper trailers, ferries, etc.

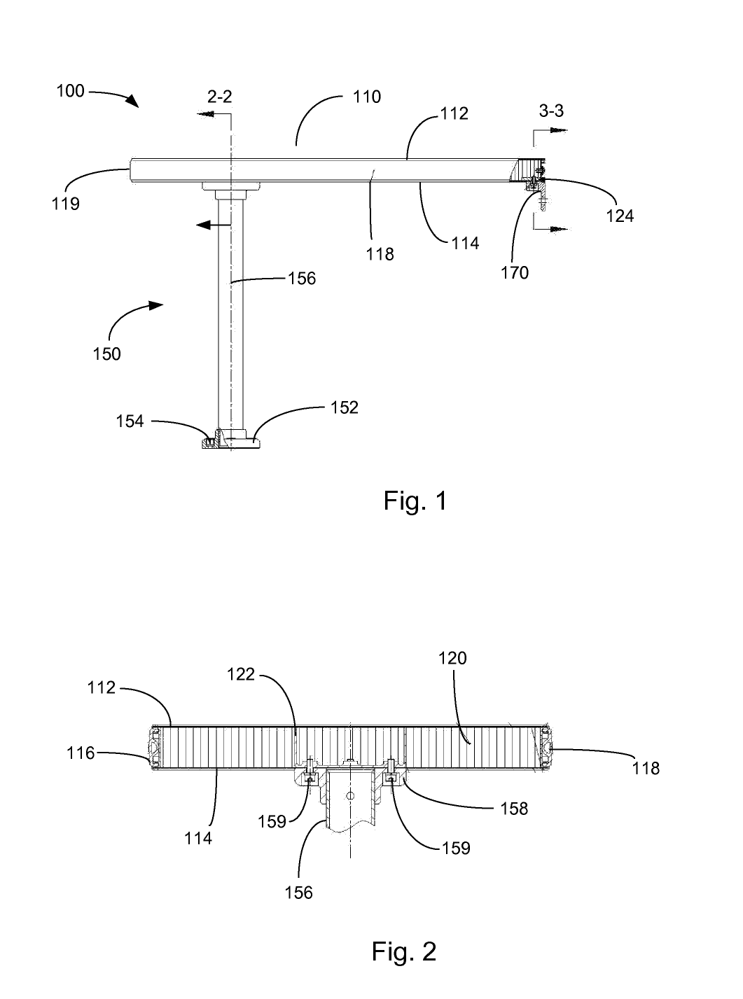

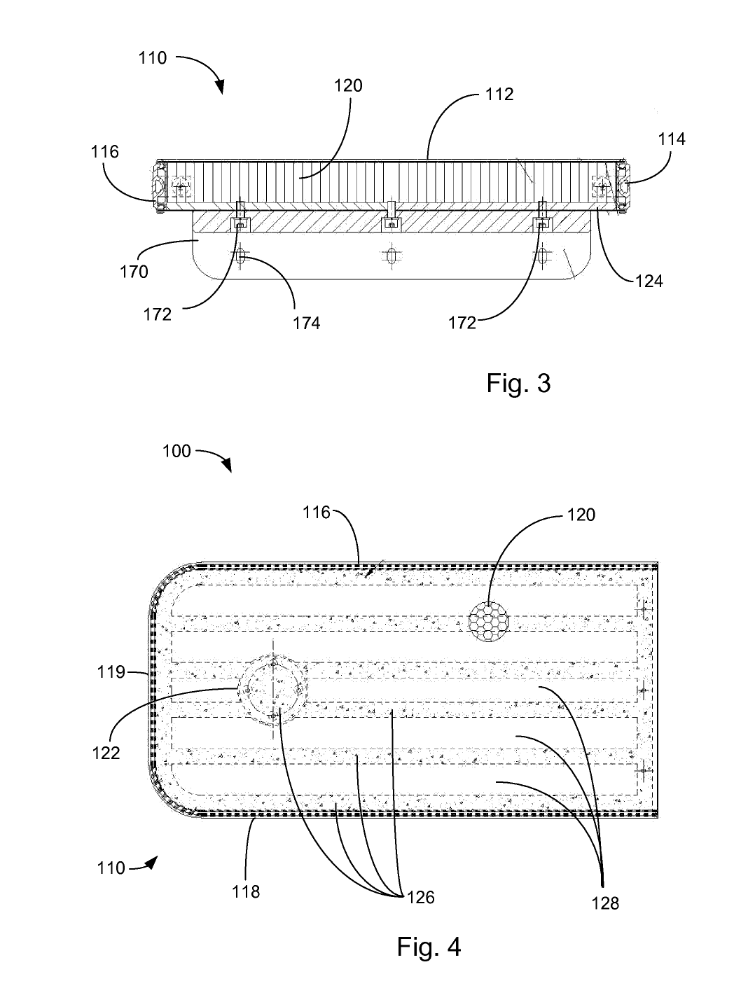

One exemplary crash energy absorbing body in table configuration is illustrated in FIGS. 1-4. In the Figures, crash energy absorbing table 100 includes table top 110, leg 150, and wall mount 170. Table top 110 may include a top skin 112, bottom skin 114, edges 116, 118, 119 forming a generally planar shape consistent with a table top. The interior of table top 110 may be filled with a filler 120 and may include structural elements such as leg support 122 and wall mount attachment 124 to provide additional strength and attachment points. Structural elements 122, 124 may be formed from a material that allows for sufficient support and to accept fasteners to secure table top 110 to a wall and to leg 150.

Filler 120 may be a honeycomb material, as shown in the cutaway window portion of FIG. 4, or may be corrugated material, or any other suitable material sufficient to provide structural strength to table top 110 and also be crushable to allow for deformation should a body impact with table top 110 with sufficient force. Filler 120 may be formed from cardboard, plastic, aluminum, etc., with the wall thickness between cells and cell size determined by the crushability and deformation of table top 110 in the event of a collision.

The exterior surfaces of table top 110, i.e., top skin 112, bottom skin 114, edges 116, 118, 119, may be formed of any suitable material such as aluminum, plastic, laminate, wood, steel, etc. The thicknesses of the various exterior surfaces may vary depending on material. The thickness may be sufficient to provide a sturdy work and support surface, while also allowing for deformation in the event of a collision with a body with minimum or no injury to the body. In some embodiments, top skin 112, bottom skin 114, edges 116, 118, 119 may be formed of different materials from each other, as desired. For example, top skin 112 may be aluminum, bottom skin 114, may be plastic, and edges 116, 118, 119 may be wood. Filler 120 may be bonded to top skin 112 and bottom skin 114 in a pattern to allow for crushing and/or deformation of table top 110 when impacted with sufficient force. As shown in FIG. 4, bonding areas 126 may be spaced apart with non-bonded areas 128 in between. In the event of an impact, non-bonded areas 128 may be crushed and/or deformed and top skin 112 and bottom skin 114 may buckle independent of filler 120 or otherwise deform to absorb energy from a collision with table top 110. The bonding agent used in bonding areas 126 may have a bonding strength such that the bond between top skin 112 and/or bottom skin 114 will fail after non-bonded areas begin to crush, allowing filler 120 in the bonded areas 136 to crush to further absorb energy. The bonding pattern shown in FIG. 4 has stripes orthogonal to edge 119 and parallel to edges 116, 118. In this embodiment, crash energy absorbing table 100 provides energy absorbing impact protection from a person impacting side 116 or 118, or both.

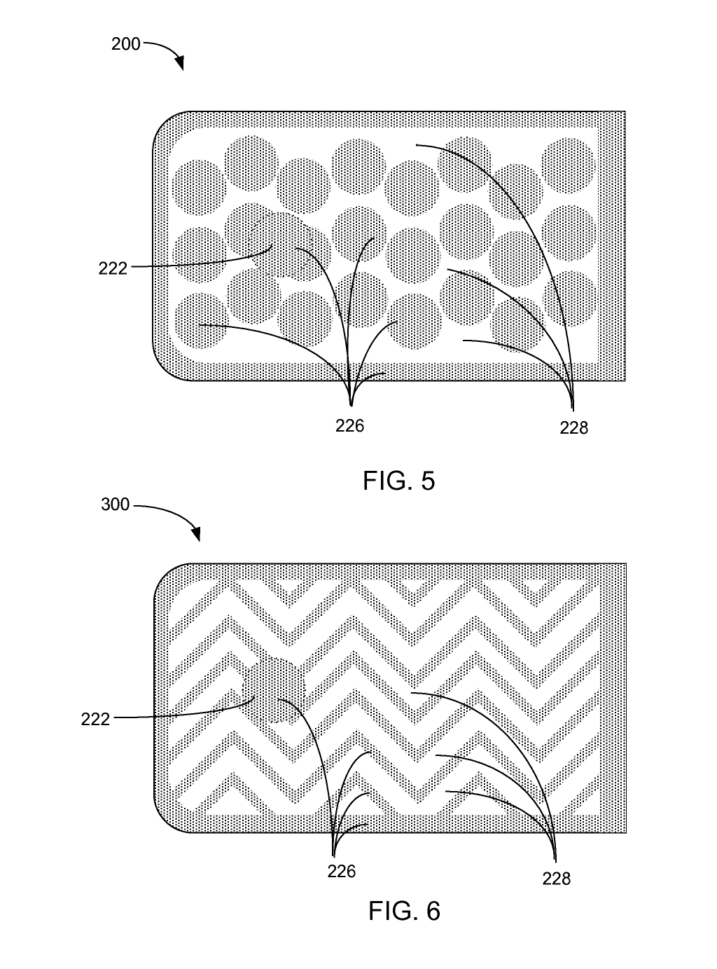

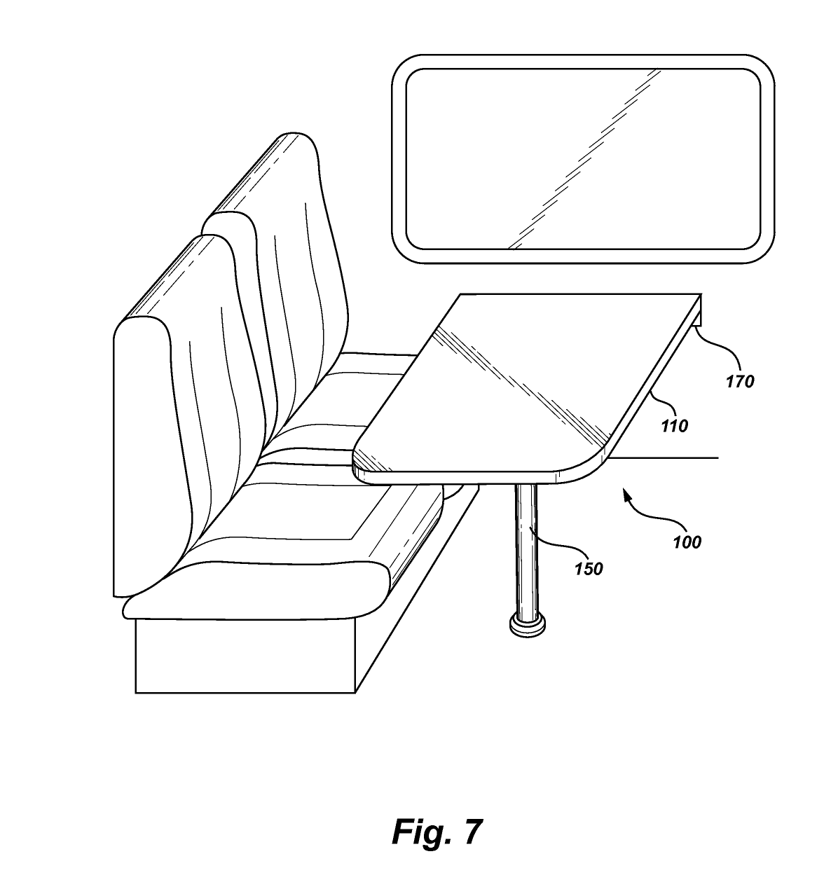

Depending on the desired use and placement in a particular application, it may be desirable to alter the bonding pattern based on likely impacts. For example, in embodiments where impact may occur from any angle, the bonding pattern may be spaced apart geometric forms, such as circles, squares, etc., that provide crush areas from any angle. In other embodiments, the pattern for bonded and non-bonded areas may be any desired pattern or configuration. For example, the bonding pattern may be circles as shown in FIG. 5 with crash energy absorbing table 200, with bonded areas 226, 222 and non-bonded areas 228. Or the bonding pattern may be zig-zag lines as shown in FIG. 6 with crash energy absorbing table 300, with bonded areas 326, 322 and non-bonded areas 328. In some embodiments, or stripes of bonded areas may be at any desired angle from the various edges 116, 118, 119, depending on the desired crash energy absorbing performance.

Crash energy absorbing table 100 may be any size or dimension useful to the particular desired application. For example, in some embodiments, crash energy absorbing table 100 may be the size of a twin bed to be used as both a table and a sleeping surface, depending on the configuration of the area in which crash energy absorbing table 100 is deployed. For example, an RV may have a table for eating and working that becomes a sleeping surface by moving cushions or a mattress onto crash energy absorbing table 100 for sleeping. Of course, crash energy absorbing table 100 may be used for various other applications, or joint applications as well.

Leg 150 may include shaft 156 and may be secured to a floor with base 152 and base fasteners 154. Similarly, leg 150 may be secured to table top 110 through attachment 158, which may be attached to leg support 122 embedded in table top 110 with fasteners 159. Leg 150 may be formed of any suitable material, such as aluminum or other metals, wood, carbon fiber, plastic, a composite of various materials, or any other suitable material. Leg 150 may be formed with dimensions sufficient to support table top 110 and to prevent damage to leg 150 from normal and anticipated use and impacts. In some embodiments, two or more legs may be used to support table top 110.

Wall mount 170 may be used to provide mounting for crash energy absorbing table 100 to a wall or vertical surface. Wall mount 170 may be a formed in a generally “L” shaped cross-section and having a length extending along an edge of table top 110 in contact or proximity with the vertical wall or surface. Wall mount 170 may be formed from any suitable material such as steel, aluminum, or other metals, carbon fiber, etc., sufficiently strong to support the weight of table top 110 and any anticipated loads on table top 110.

Wall mount 170 maybe secured to the vertical wall or surface with fasteners 174. A structural support may be provided within the vertical wall or surface to provide sufficient attachment and anchoring for fasteners 174. Wall mount may be secured to table top 110 through fasteners 172 that engage with wall mount attachment 124.

Fasteners 172, 174, 159, 154 may be any fastener sufficient to secure the respective portions of crash energy absorbing table 100 to each other and to other surfaces. Fasteners may be bolts, screws, lags, rivets, etc., as desired and suitable for a particular application. Similarly, in some embodiments, crash energy absorbing table 100 may be secured together and to surfaces permanently with welding, gluing, bonding, or other desired joining process.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

What is claimed is:

1. A crash energy absorbing furniture top for use in a moving vehicle, the furniture top comprising:
a top skin;
a bottom skin; and
a crash energy absorbing material disposed between the top skin and the bottom skin, the crash energy absorbing material being bonded to the top skin in a substantially regular pattern of bonded areas;
the crash energy absorbing furniture top being capable of absorbing energy by deforming when an individual collides with the crash energy absorbing furniture top, the deforming reducing the risk of injury to the individual.

2. The crash energy absorbing furniture top of claim 1, wherein a total bonded area is generally equal to a total non-bonded area.

3. The crash energy absorbing furniture top of claim 1, wherein the regular pattern is a pattern of alternating stripes of bonded areas and non-bonded areas.

4. The crash energy absorbing furniture top of claim 3, wherein the stripes are parallel to an edge of the crash energy absorbing furniture top.

5. The crash energy absorbing furniture top of claim 1, wherein the furniture top is a table top.

6. The crash energy absorbing furniture top of claim 1, wherein the crash energy absorbing material is a honeycomb shaped material.

7. The crash energy absorbing furniture top of claim 6, wherein the crash energy absorbing material is formed of aluminum.

8. The crash energy absorbing furniture top of claim 1, wherein the top skin is made of aluminum.

9. The crash energy absorbing furniture top of claim 1, wherein the crash energy absorbing furniture top is generally rectangular.

10. The energy absorbing furniture top of claim 1, wherein the crash energy absorbing material is formed of paper.

11. The crash energy absorbing furniture top of claim 1, wherein the crash energy absorbing material is formed of plastic.

12. The crash energy absorbing furniture top of claim 1, wherein the bonded area includes a portion extending around the exterior perimeter of the body.

13. The crash energy absorbing furniture top of claim 1, wherein the bonding pattern has six bonded parallel stripes separated by five non-bonded stripes.

14. The crash energy absorbing furniture top of claim 13, wherein the bottom skin is bonded to the crash energy absorbing material in the same pattern as the top skin.

15. The crash energy absorbing furniture top of claim 1, wherein the regular pattern is a wavy stripe pattern of alternating bonded and non-bonded striped areas.

16. The crash energy absorbing furniture top of claim 1, wherein the regular pattern is circles of bonded areas separated by non-bonded area.

17. The crash energy absorbing furniture top of claim 1, wherein the regular pattern includes repeating geometric shapes of bonded areas.
